(19) United States
(12) Patent Application Publication
(10) Pub. No.: US 2010/0053327 A1
(43) Pub. Date: Mar. 4, 2010

(54) VEHICLE PERIPHERY IMAGE DISPLAYING APPARATUS AND VEHICLE PERIPHERY IMAGE DISPLAYING SYSTEM

(75) Inventors: Kunikazu Nakayama, Nagoya-city (JP); Norifumi Matsukawa, Kariya-city (JP); Koji Ashie, Nagoya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/547,706

(22) Filed: Aug. 26, 2009

(30) Foreign Application Priority Data
Sep. 2, 2008 (JP) 2008-224587

(51) Int. Cl. H04N 7/18

(52) U.S. Cl. 348/148; 348/E07.085

(57) ABSTRACT

A vehicle periphery image displaying apparatus is disclosed that is coupled with (i) a camera for capturing an image of a region around the vehicle and (ii) a display device for displaying the image so that power is supplied to the camera in accordance with a camera activation signal for triggering activation of the camera. The vehicle periphery image displaying apparatus is configured to determine whether the camera activation signal is inputted, and configured to determine whether the camera is in an activated state. The vehicle periphery image displaying apparatus outputs a control signal to the camera when it is determined that the camera activation signal determination section determines that the camera activation signal is inputted and when it is determined that the camera is in the activated state.

### CROSS REFERENCE TO RELATED APPLICATION

The present application is based on Japanese Patent Applications No. 2008-224587 filed on Sep. 2, 2008, disclosure of which is incorporated herein by reference.

### BACKGROUND OF THE INVENTION

1. Field of the Invention

The present invention relates to a vehicle periphery image displaying apparatus that includes a controller for outputting a control signal to a camera adapted to capture an image of a region around a vehicle, and that displays the captured image on a screen of a display device. The present invention also relates to a vehicle periphery image displaying system including the vehicle periphery image displaying apparatus.

2. Description of Related Art

There is known so called a back guide monitor that utilizes a backup camera for capturing an image of a region rearward of a vehicle and displays the image on a screen of a display device.

There is also known a vehicle periphery monitoring system that includes multiple sensors and a controller. The multiple sensors sense an object existing around a vehicle. The controller detects the object by using the sensors and displays the object on a screen of the display device. Such a vehicle periphery monitoring system is disclosed in JP-2002-59798A for instance.

According to the above-described back guide monitor, since a field of view, e.g., an angle of view and an angle of depression, of the camera is constant, it is difficult to visualize an area just close to a bumper of the vehicle or an obstacle exiting around a corner part of the vehicle.

### SUMMARY OF THE INVENTION

In view of the above and other points, it is an objective of the present invention to provide a vehicle periphery image displaying apparatus and system that is capable of outputting a control signal to a camera and capable of displaying an image that is based properly on the control signal.

According to a first aspect of the present invention, there is provided a vehicle periphery image displaying apparatus for a vehicle equipped with (i) a camera for capturing an image of a region around the vehicle and (ii) a display device for displaying the captured image so that power is supplied to the camera in accordance with a camera activation signal for triggering activation of the camera. The vehicle periphery image displaying apparatus includes: a camera activation signal determination section that is configured to determine whether the camera activation signal is inputted; a camera state determination section that is configured to determine whether the camera is in an activated state; and a control signal output section that is configured to output a control signal to the camera when the camera activation signal determination section determines that the camera activation signal is inputted and when the camera state determination section determines that the camera is in the activated state.

According to a second aspect of the present invention, there is provided a vehicle periphery image displaying system for a vehicle equipped with an obstacle sensor for sensing an object existing around the vehicle and providing a sensing result. The vehicle periphery image displaying system includes: a camera configured to capture an image of a region around the vehicle; a display device configured to display the image, and configured to supply a power to the camera to activate the camera when a camera activation signal indicates that the camera is to be activated; and a controller. The controller includes: a distance calculation section configured to calculate a distance to the object based on the sensing result of the obstacle sensor; a camera activation signal determination section configured to determine whether the camera activation signal indicates that the camera is to be activated; a camera state determination section configured to determine whether the camera is in an activated state; and a control signal output section configured to output a control signal to the camera when it is determined that the camera activation signal indicates that the camera is to be activated and when it is determined that the camera is in the activated state. The control signal instructs the camera to change a field of view of the camera in accordance with the calculated distance to the object.

According to the above vehicle periphery image displaying apparatus and system, the control signal is outputted to the camera when it is determined that the camera activation signal is inputted and when it is determined that the camera is in the activated state. Therefore, the camera can receives the control signal after the camera is in the activated state, and the display device can display an image that is based properly on the control signal.

### BRIEF DESCRIPTION OF THE DRAWINGS

The above and other objects, features and advantages of the present invention will become more apparent from the following detailed description made with reference to the accompanying drawings. In the drawings:

FIG. 1 is a bock diagram illustrating a vehicle periphery image displaying apparatus according to one embodiment;

FIG. 2 is a circuit diagram illustrating a camera power detection circuit;

FIG. 3 is a flowchart illustrating an output procedure;

FIG. 4 is a timing chart illustrating timing of inputting a reverse signal, and timing of outputting a control signal via serial communications; and

FIG. 5 is a bock diagram illustrating a vehicle periphery image displaying apparatus according to a comparison embodiment.

### DETAILED DESCRIPTION OF THE EXEMPLARY EMBODIMENTS

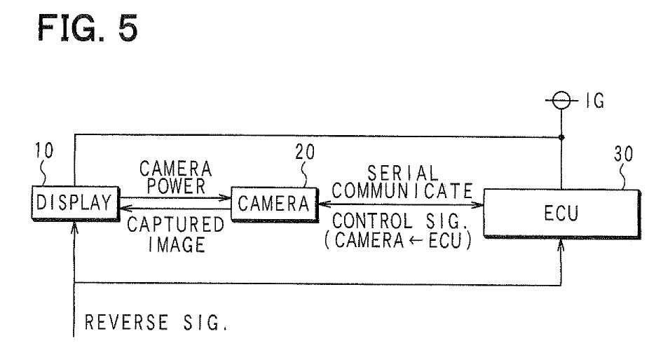

A Vehicle periphery image displaying apparatus according to a comparison example is described below with reference to FIG. 5. The vehicle periphery image displaying apparatus may be regarded as a combination of a back guide monitor and a vehicle periphery image displaying device. The vehicle periphery image displaying apparatus calculates a distance to an object existing around the vehicle and changes an angle view of the camera in accordance with the calculated distance. Such a vehicle periphery image displaying apparatus may enable a display device to display images suitable to vehicle peripherical situation, in such manner that a wide-angle image is displayed when no obstacle is detected, and an enlarged image of an obstacle is displayed when the obstacle is detected.

The vehicle periphery image displaying apparatus illustrated in FIG. 5 includes a back guide monitor and a vehicle periphery image displaying device. The back guide monitor has a camera 20 and a display device 10. The vehicle periphery image displaying apparatus includes a clearance sonar ECU (electronic control unit) 30.

When an ignition switch of a vehicle is turned on, an IG power is supplied from a battery of the vehicle to the display device 10 and the clearance sonar ECU 30 via an IG terminal. When a reverse signal, which indicates that a gear shift lever is in a reverse position, is input to the display device 10, the power is supplied to the camera 20 via the display device 10. When the power is supplied to the camera 20 via the display device 10, the camera is activated, and the display device 10 displays an image captured by the camera 20.

The clearance sonar ECU 30 calculates a distance between the vehicle and an object existing around the vehicle, and outputs a control signal to the camera 20 when the reverse signal is input to the clearance sonar ECU 30. The control signal instructs the camera to change an area to be captured or to change the angle of view in accordance with the calculated distance. In the above, data is transmitted and received between the clearance sonar ECU 30 and the camera 20 via serial communications.

In the above-described vehicle periphery image displaying apparatus, after the reverse signal is inputted to the display device 10, it takes time for the camera 20 to be activated by the power supplied from the display device 10. If the clearance sonar ECU 30 outputs the control signal to the camera 20 in this period, the camera 20 cannot receive the control signal, and the display device 10 cannot display images that are based on the control signal.

In view of the above and other difficulties, a vehicle periphery image displaying apparatus according to exemplary embodiments are described below.

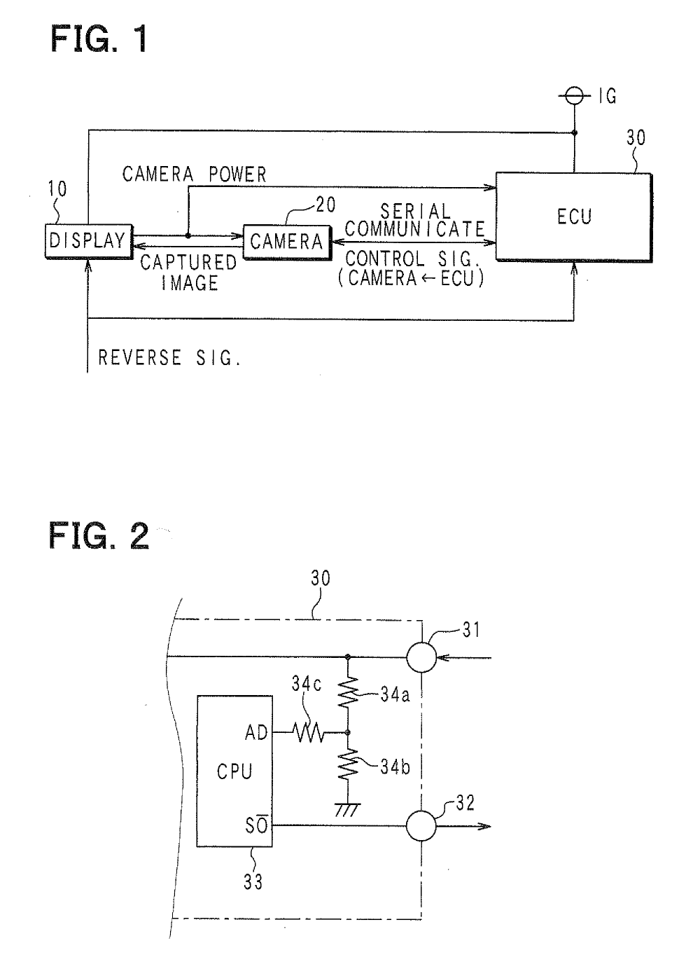

FIG. 1 illustrates a vehicle periphery image displaying apparatus according to one embodiment. The vehicle periphery image displaying apparatus includes a clearance sonar ECU 30 acting as a controller. The clearance sonar ECU 30 outputs a control signal to a camera for capturing an image of a region rearward of a vehicle. The vehicle periphery image displaying apparatus causes a display device 10 to displays the image captured by the camera 20.

The display device 10 includes a screen such as a liquid crystal display (LCD) screen or the like. The display device 10 displays an image on the screen in accordance with an image signal inputted from the camera 20, a navigation apparatus (not shown) or the like.

The camera 20 outputs a captured image to the display device 10. In accordance with a control signal from the clearance sonar ECU 30, the camera 20 changes a filed of view by changing, for example, an angle of view, an angle of depression, a magnification ratio, an imaging direction, or the like.

The clearance sonar ECU 30 is configured as, for example, a computer including a CPU 33 (see FIG. 2) and a memory. The CPU 33 performs various processes in accordance with programs stored in the memory.

The clearance sonar ECU 30 performs a process associated with transmitting a radio wave toward a region rearward of the vehicle and detecting the radio wave reflected from an object existing around the vehicle, and thereby, the clearance sonar ECU 30 calculates a distance to the object existing around the vehicle. In connection with the above process, the transmission and reception of the radio wave may done by multiple sensors (not shown) attached to a rear bumper of the vehicle or the like. The clearance sonar ECU 30 also performs a process of outputting a control signal, which instructs the camera 20 to change an imaging region in accordance with the calculated distance. Data transmission and reception between the clearance sonar ECU 30 and the camera 20 are performed via serial communications.

A reverse signal, which indicates that a gear shift lever of the vehicle is in a reverse position, is inputted to both of the display device 10 and the clearance sonar ECU 30 when the gear shift lever is in the reverse position. In the present embodiment, the reverse signal is obtained from a connector attached to a back of vehicle meters via a dedicated line.

When an ignition switch of the vehicle is turned on, an IG power is supplied from a battery of the vehicle to the display device 10 and the clearance sonar ECU 30 via an IG terminal. When the reverse signal is inputted to the display device 10, a power is supplied to the camera 20 via the display device 10. The camera 20 employed in the present embodiment is instantaneously activated when the power is supplied from the display device 10. The camera 20 starts outputting a captured image to the display device 10 immediately after the activation.

The vehicle periphery image displaying apparatus determines whether the camera 20 is activated, in order to prevent the clearance sonar ECU 30 from outputting the control signal to the camera 20 during the following period. The period is between a time when the reverse signal is inputted to the display device 10 and a time when the camera 20 is activated by the power supplied from the display device 10. After confirming that the camera 20 is in activated state, the vehicle periphery image displaying apparatus outputs the control signal to the camera 20.

The clearance sonar ECU 30 includes a camera power detection circuit for detecting a power voltage of the camera 20. Using the camera power detection circuit, the clearance sonar ECU 30 determines whether the power voltage of the camera rises, and thereby, determines whether the camera 20 is in an activated state.

FIG. 2 illustrates a camera power detection circuit. The clearance sonar ECU 30 includes a camera power monitor terminal 31, a serial signal output terminal 32 and resistors 34a to 34c in addition to the CPU 33. The resistors 34a to 34c provide the camera power detection circuit.

The camera power monitor terminal 31 and a power terminal (not shown) of the camera 20 are connected with each other through a cable. A voltage that depends on the power voltage of the camera 20 is applied to the camera power monitor terminal 31.

The camera power monitor terminal 31 is connected in series with the resistor 34a and the resistor 34b. The voltage applied to the camera power monitor terminal 31 is divided by the resistor 34a and the resistor 34b. The divided voltage is applied to an AD terminal of the CPU 33 via the resistor 34c. The CPU 33 detects the power voltage of the camera 20 by A-D converting the voltage applied to the AD terminal.

The CPU 33 includes an SO terminal for serial communications. The SO terminal is connected with a serial communication terminal of the camera 20 via the serial signal output terminal 32. The CPU 33 outputs a variety of control signals from the SO terminal to the camera 20 via the serial communication signal output terminal 32.

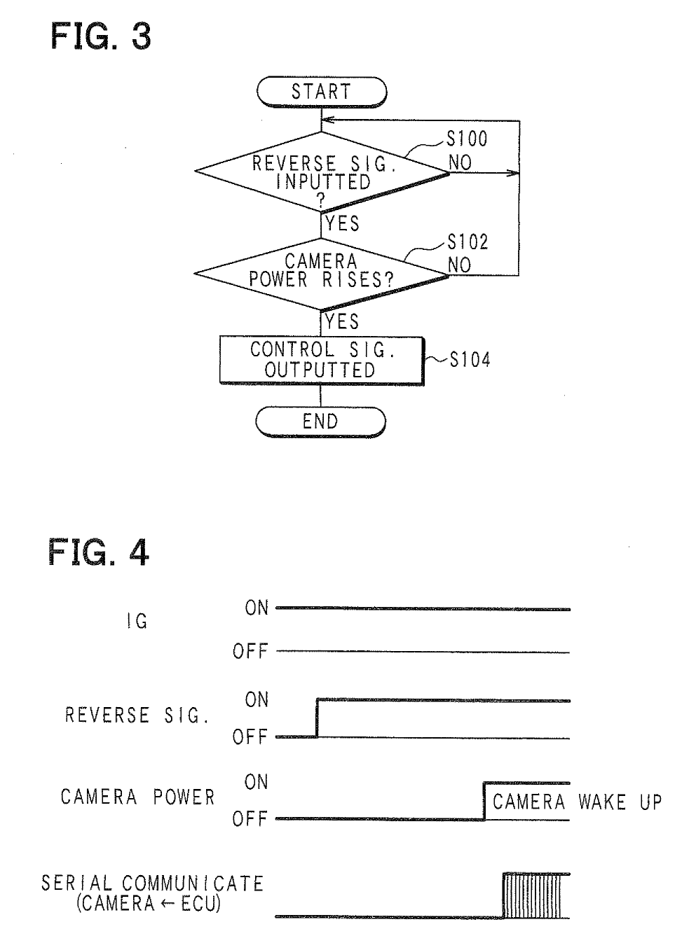

FIG. 3 is a flowchart illustrating an output procedure for the clearance sonar ECU 30 to output a control signal to the camera 20. When the ignition switch of the vehicle is turned on, and when the power is supplied to the display device 10 and the clearance sonar ECU 30, the clearance sonar ECU 30 starts operation and starts performing the output procedure illustrated in FIG. 3.

At S100, it is determined whether the reverse signal is inputted. When the gear shift lever of the vehicle is in positions that cause the vehicle to move forward, or when the gear shift lever is in a parking (P) position or a neutral (N) position, it is determined at S100 that the reverse signal is not inputted, corresponding to “NO” at S100, and the process S100 is re-performed. The positions of the gear shift lever that cause the vehicle to move forward are, for example, a drive (D) position, a second (2) position, a low (L) position and the like. When the gear shift lever is in the reverse position, and it is determined at S100 that the reverse signal is inputted, corresponding to “YES” at S100, and the process proceeds to 5102. At S102, it is determined whether the power voltage of the camera 20 rises, based on for example a result of the monitoring of the voltage applied to the AD terminal of the CPU 33. In the present embodiment, the clearance sonar ECU 30 determines whether the power voltage of the camera 20 rises, and thereby determining whether the camera is in the activated state.

When it is determined that the power voltage of the camera 20 does not rise, corresponding to “NO” at S102, the process returns to S100. In such a case, the control signal is not outputted to the camera 20. When the power is supplied to the camera 20 via the display device 10 in response to the input of the reverse signal, the power voltage of the camera 20 rises. In such a case, it is determined that the power voltage of the camera 20 rises, corresponding to “YES” at S102, and the process proceeds to S104. At S104, the control signal is transmitted via serial communications. For example, the clearance sonar ECU 30 outputs the control signal, which instructs the camera 20 to change an imaging region by, for example, changing a ratio of magnification, an imaging direction or the like in accordance with the distance between the vehicle and the object existing around the vehicle. When the camera 20 receives the control signal, the camera 20 captures images of regions around the vehicle in accordance with the control signal and outputs the captured images to the display device 10.

FIG. 4 is a timing chart illustrating timing of inputting a reverse signal, and timing of transmitting a control signal via serial communications. As shown in FIG. 4, even after the reverse signal is inputted, in other words, even after the reverse signal is switched from an OFF state into an ON state, the control signal is not transmitted during the power of the camera is in an OFF state. When the power voltage of the camera 20 rises, in other words, when the camera 20 wakes up, the control signal is transmitted to the camera 20 via serial communications. As seen above, the control signal is transmitted after the camera 20 is activated. Thus, the camera 20 can receive the control signal in a normal manner, can capture images of regions around the vehicle in accordance with the control signal, and can output the images to the display device 10.

According to the above configuration, the clearance sonar ECU 30 includes the camera power detection circuit for detecting the power voltage of the camera 20, and determines whether the power voltage of the camera 20 rises by using the camera power detection circuit, and thereby, determines whether the camera is in the activated state. When it is determined that the reverse signal is inputted and when it is determined that the camera 20 is in the activated state, the control signal is transmitted to the camera 20. Thus, the camera 20 can receive the control signal after being in the activated state. Therefore, it becomes possible to display an image that is based properly on the control signal.

The above-described embodiments can be modified in various ways, examples of which are described below.

In the above embodiments, the controller includes the camera power detection circuit for detecting the power voltage of the camera, and determines whether the power voltage of the camera rises by using the camera power detection circuit, thereby determining whether the camera is in the activate state. Alternatively, the clearance sonar ECU may not include the camera power detection circuit. For example, the image captured by the camera may be inputted to the clearance sonar ECU, and the clearance sonar ECU may determines whether the camera is in the activated state by determining whether to receive the image captured by the camera. Alternatively, the clearance sonar ECU may outputs an input signal to the camera, and may determine whether the camera is in the activated state based on determining whether the clearance sonar ECU receives a response signal (e.g., ACK signal) indicating that the camera successfully receives the input signal.

In the above embodiment, the reverse signal is inputted via the dedicated line to the clearance sonar ECU 30 from a connector etc. attached to a back of vehicle meter. Alternatively, the reverse signal may be inputted to the clearance sonar ECU 30 from an ECU in the vehicle such as a meter ECU, an engine ECU or the like via an in-vehicle LAN such as a CAN and the like.

In the above embodiments, the clearance sonar ECU is illustrated as a controller, which calculates a distance to an object existing around the vehicle by using a sensor equipped in the vehicle, and which outputs the control signal to the camera, the control signal instructing the camera to change an area of the region to be captured. However, the controller is not limited to the clearance sonar ECU 30. The controller may be an electronic control unit other than the clearance sonar ECU 30.

In the above embodiments, the backup camera for capturing an image of a region rearward of the vehicle is illustrated as a camera. Further, a camera activation signal is illustrated as the reverse signal, which indicates that the gear shift lever 1 of the vehicle is in the reverse gear position. However, the camera and the camera activation signal are not limited to the above examples. For example, the camera may include a front camera for capturing an image of a region forward of the vehicle. The camera activation signal may include a signal (e.g., a D range signal) indicating that the gear shift lever of the vehicle is in a drive (D) position. In the above case, the D range signal may be inputted to the clearance sonar ECU via a dedicated signal line, or, the D range signal may be inputted to the clearance sonar ECU via an in-vehicle LAN such as CAN and the like from an electronic control unit such as a meter ECU, an engine ECU or the like.

Alternatively, the camera may include one or mores cameras, which are for example a side camera, a backup camera and a front camera. Each of the above cameras may be activated in accordance with an input of a corresponding camera activation signal. An image captured by each camera may be displayed on a screen of the displays device 10.

In the above embodiments, the power is supplied to the camera from the display device in accordance with an input of the camera activation signal. Alternatively, the power may be supplied to the camera from a component different from the display device.

In the above embodiments and modifications, a clearance sonar ECU is illustrated as an example of a controller of a vehicle periphery image displaying apparatus. The clearance sonar ECU performing S100 is illustrated as an example of a camera activation signal determination section or means. The clearance sonar ECU performing S102 is illustrated as an example of a camera state determination section or means. The clearance sonar ECU performing S104 is illustrated as an example of a control signal output section or means.

While the invention has been described above with reference to various embodiments thereof, it is to be understood that the invention is not limited to the above described embodiments and constructions. The invention is intended to cover various modifications and equivalent arrangements. In addition, while the various combinations and configurations described above are contemplated as embodying the invention, other combinations and configurations, including more, less or only a single element, are also contemplated as being within the scope of embodiments.

Further, each or any combination of processes, steps, or means explained in the above can be achieved as a software section or unit (e.g., subroutine) and/or a hardware section or unit (e.g., circuit or integrated circuit), including or not including a function of a related device; furthermore, the hardware section or unit can be constructed inside of a microcomputer.

Furthermore, the software section or unit or any combinations of multiple software sections or units can be included in a software program, which can be contained in a computer-readable storage media or can be downloaded and installed in a computer via a communications network.

What is claimed is:

1. A vehicle periphery image displaying apparatus for a vehicle equipped with (i) a camera for capturing an image of a region around the vehicle and (ii) a display device for displaying the captured image so that power is supplied to the camera in accordance with a camera activation signal for triggering activation of the camera, the vehicle periphery image displaying apparatus comprising:
a controller including:
a camera activation signal determination section that is configured to determine whether the camera activation signal is inputted;
a camera state determination section that is configured to determine whether the camera is in an activated state; and
a control signal output section that is configured to output a control signal to the camera when the camera activation signal determination section determines that the camera activation signal is inputted and when the camera state determination section determines that the camera is in the activated state.

2. The vehicle periphery image displaying apparatus according to claim 1,
wherein the controller further including
a camera power detection circuit that is configured to detect a power voltage of the camera and is configured to provide a camera power detection result,
wherein the camera state determination section is configured to determine whether the power voltage of the camera rises based on the camera power detection result,
wherein the camera state determination section determines that the camera is in the activated state when it is determined that the power voltage of the camera rises,
wherein the camera state determination section determines that the camera is not in the activated state when it is determined that the power voltage of the camera does not rise.

3. The vehicle periphery image displaying apparatus according to claim 1,
wherein the controller is configured to calculate a distance to an object existing around the vehicle by using a sensor equipped in the vehicle,
wherein the control signal output section is configured to output the control signal to the camera, the control signal instructing the camera to change an imaging area of the region around the vehicle in accordance with the calculated distance to the object.

4. The vehicle periphery image displaying apparatus according to claim 1,
wherein the power is supplied to the camera from the display device in response to an input of the camera activation signal.

5. The vehicle periphery image displaying apparatus according to claim 1,
wherein the camera includes a back camera, which captures the image of an area rearward of the vehicle,
wherein the camera activation signal includes a reverse signal, which indicates that a gear shift lever of the vehicle is in a reverse position.

6. The vehicle periphery image displaying apparatus according to claim 5,
wherein the reverse signal is inputted to the controller through a dedicated line.

7. The vehicle periphery image displaying apparatus according to claim 53
wherein the reverse signal is inputted from an electronic control unit to the controller through an in-vehicle LAN, the electronic control unit being arranged in the vehicle.

8. The vehicle periphery image displaying apparatus according to claim 1,
wherein the camera includes a front camera, which captures an image of a area forward of the vehicle,
wherein the camera activation signal includes a forward signal, which indicates that a gear shift lever of the vehicle is in a forward gear position that cause the vehicle to move forward.

9. The vehicle periphery image displaying apparatus according to claim 8,
wherein the forward signal is inputted to the controller through a dedicated line.

10. The vehicle periphery image displaying apparatus according to claim 8,
wherein the forward signal is inputted from an electronic control unit to the controller through an in-vehicle LAN, the electronic control unit being arranged in the vehicle.

11. A vehicle periphery image displaying system for a vehicle equipped with a sensor for sensing an object existing around the vehicle and providing a sensing result, the vehicle periphery image displaying system comprising:
a camera configured to capture an image of a region around the vehicle;
a display device configured to display the captured image, and configured to supply a power to the camera to activate the camera when a camera activation signal indicates that the camera is to be activated; and
a controller including:
a distance calculation section configured to calculate a distance to the object based on the sensing result of the sensor;
a camera activation signal determination section configured to determine whether the camera activation signal indicates that the camera is to be activated;
a camera state determination section configured to determine whether the camera is in an activated state; and
a control signal output section configured to output a control signal to the camera when it is determined that the camera activation signal indicates that the camera is to be activated and when it is determined that the camera is in the activated state, the control signal instructing the camera to change a field of view of the camera in accordance with the calculated distance to the object.
